(19) United States
(12) Patent Application Publication
(10) Pub. No.: US 2017/0255640 A1
(43) Pub. Date: Sep. 7, 2017

(54) INTERACTION PROVIDING METHOD FOR DELETING QUERY

(71) Applicant: NAVER Corporation, Seongnam-si (KR)

(72) Inventors: Hyeeun Noh, Seongnam-si (KR); Hyo Jung Kim, Seongnam-si (KR)

(21) Appl. No.: 15/433,611

(22) Filed: Feb. 15, 2017

(30) Foreign Application Priority Data
Mar. 3, 2016 (KR) 10-2016-0025835

(51) Int. Cl. G06F 17/30; G06F 3/16; G06F 3/0488

(52) U.S. Cl. CPC G06F 17/30117; G06F 17/30696; G06F 17/30769; G06F 3/04883; G06F 3/167; G06F 3/0481

(57) ABSTRACT

Disclosed is an interaction providing method implemented by a computer, for deleting a query input into a user terminal. The interaction providing method includes: receiving the query from the user terminal; reading the query in response to the receiving of the query input; providing the query and a query result concerning the query to the user terminal in response to the reading of the query such that the query and the query result are output; receiving an input of a swipe command over the query output to the user terminal; and deleting the query and the query result in response to the receiving of the input of the swipe command over the query.

A claim for priority under 35 U.S.C. §119 is made to Korean Patent Application No. 10-2016-0025835 filed Mar. 3, 2016, in the Korean Intellectual Property Office, the entire contents of which are hereby incorporated by reference.

### BACKGROUND

The following description relates to a technique of correcting a query, and more particularly, relates to an interaction providing method for deleting a query.

As information and communication technologies have been developed, artificial intelligence techniques are mounted on smart devices, and various developments utilizing them have been actively advanced. When a command is input from a user to a smart device in voice, a voice recognition service of processing a partial function is provided in response to the command. For example, a user may control the basic functions of a smartphone, such as dialing, music play, map search, and the like, with voice through a smart device.

There has been provided an interactive search service in which a user inputs a query through a smart device and an answer to the query of the user is provided in conversational voice type based on the search results. The interactive search service implies that, when a search word is input from a user in a voice, the search intention of the user is recognized to rapidly search for information most approximate to the search intention of the user.

In this case, when the query that is input in a voice through a user terminal is incorrectly input or recognized, the user may not receive a query result desired by the user. Thus, after directly correcting the text of the query displayed on the smart device, the user must transmit the corrected query to the interactive search service again to receive a result to the corrected query, so that the procedure is very inconvenient. Therefore, there is a need to improve the procedure of correcting a query in the interactive search service.

### SUMMARY

Embodiments of the inventive concept provide an interaction providing method which is capable of reading a query, and providing the query and a query result concerning the query such that the query and the query result are output on the display of a user terminal when the input of the query from a user is received. When an error occurs in the query and the query result, the query is deleted by inputting a swipe on the display of the user terminal and it is induced to input the query again.

According to an aspect of an embodiment, there is provided an interaction providing method implemented by a computer. The interaction providing method includes receiving a query input from a user terminal, reading the query in response to the receiving of the query input, providing the query and a query result concerning the query to the user terminal in response to the reading of the query such that the query and the query result are output, receiving an input of a swipe command over the query output on the display of the user terminal, and deleting the query and the query result in response to the receiving of the input of the swipe command over the query.

The receiving of the query input from the user terminal may include inputting text or audio data.

The providing of the query and the query result to the user terminal may include providing audio and text data corresponding to the query and the query result to the user terminal such that the audio and text data are output.

The providing of the query and the query result to the user terminal may include providing the query result in a short-answer type or in a conversational sentence type when the query and the query result are output.

The providing of the query and the query result may include outputting the query and the query result through an interactive interface of the user terminal and providing the history of the query and the query result to the interactive interface.

The receiving of the swipe command may include, when the query input to the user terminal is erroneously read, inputting the swipe command over the query if the erroneously read query and query result are output or if the query is re-input.

The receiving of the swipe command may include, when a swipe command for a query, which is desired to be deleted among the query and the query result output to the user terminal, is input, selectively deleting the query over which the swipe command is input and the query result.

The deleting of the query and the query result may include outputting a pop-up window which is used to determine whether to cancel the deletion of the query and the query result to the user terminal for a time.

The deleting of the query and the query result may include, when a deletion cancel command to cancel the deletion of the query is received, restoring the query and the query result, wherein the deletion cancel command may be input through the pop-up window output to the user terminal.

According to another aspect of an embodiment, there is provided a computer-readable recording medium storing a computer program. The computer program, when executed by a computer, causes the computer to perform an interaction providing method. The interaction providing method includes receiving a query input from a user terminal, reading the query in response to the receiving of the query input, providing the query and a query result concerning the query to the user terminal in response to the reading of the query such that the query and the query result are output, receiving an input of a swipe command over the query output to the user terminal, and deleting the query and the query result in response to the receiving of the input of the swipe command over the query.

According to still another aspect of an embodiment, there is provided a server for providing an interaction. The server includes a first reception unit which receives a query input from a user terminal, a read unit which reads the query in response to the receiving of the query input, a providing unit which provides the query and a query result concerning the query to the user terminal in response to the reading of the query such that the query and the query result are output, a second reception unit which receives an input of a swipe command over the query output to the user terminal, and a deletion unit which deletes the query and the query result in response to the receiving of the input of the swipe command over the query.

Text or audio data may be input to the first reception unit in a verbal word or text type.

The providing unit may provide audio and text data corresponding to the query and the query result to the user terminal such that the audio and text data are output.

The providing unit may provide the query result in a short-answer type or in a conversational sentence type when the query and the query result are output.

The providing unit may output the query and the query result through an interactive interface of the user terminal and may provide the history of the query and the query result to the interactive interface.

When the query input from the user terminal is erroneously read, the second reception unit may input the swipe command over the query if the erroneously read query and query result are output or if the query is re-input.

When a swipe command that a query is desired to be deleted among the query output to the user terminal and the query result may be input, the second reception unit may selectively delete the query over which the swipe command is input and the query result.

The deletion unit may output a pop-up window which is used to determine whether to cancel the deletion of the query and the query result to the user terminal for a preset time.

When a deletion cancel command to cancel the deletion of the query is received, the deletion unit may restore the query and the query result, and wherein the deletion cancel command is input through the pop-up window output to the user terminal.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a view illustrating an example of a network environment according to an embodiment;

FIG. 2 is a block diagram illustrating the internal configurations of a user terminal and a server according to an embodiment;

FIG. 3 is a block diagram illustrating examples of elements which may be included in a processor of an interaction providing server according to an embodiment;

FIG. 4 is a view illustrating an example of a query input from a user terminal according to an embodiment;

FIG. 5 is a view illustrating an example of a query result to an input query according to an embodiment;

FIG. 6 is a view illustrating an example of a deletion of a query according to an embodiment;

FIG. 7 is a view illustrating an example of restoring a query according to an embodiment; and

FIG. 8 is a flowchart illustrating a method of providing an interaction between a user terminal and an interaction providing server according to an embodiment.

### DETAILED DESCRIPTION

Hereinafter, an embodiment will be described in detail with reference to accompanying drawings.

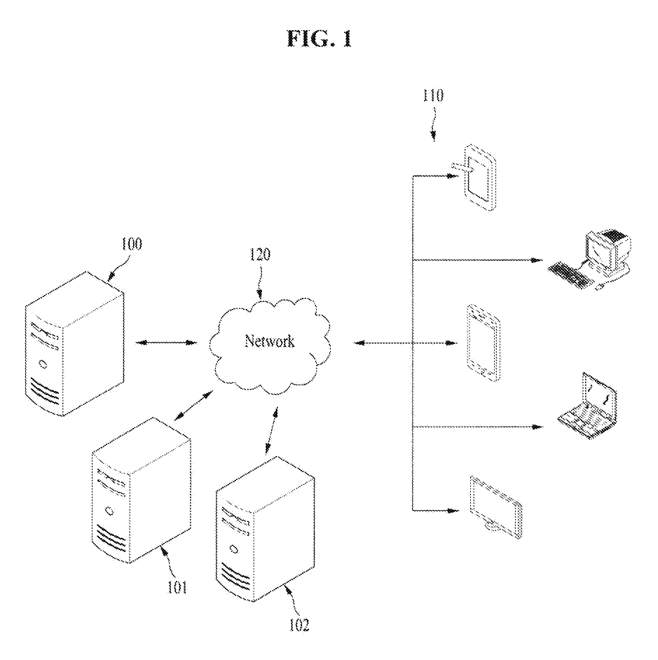

FIG. 1 is a view illustrating an example of a network environment according to an embodiment.

FIG. 1 shows an example of a network environment including a plurality of user terminals 110, a plurality of servers 100, 101 and 102, a network 120. FIG. 1 is a view illustrating one example for the purpose of description of an embodiment, and the numbers of user terminals 110 and the servers 100, 101 and 102 are not limited to those of FIG. 1.

Any of the user terminals 110 may be a stationary terminal or a portable terminal implemented with a computer device. For example, the user terminal 110 may include a smart phone, a mobile phone, a GPS navigator, a computer, a laptop computer, a digital broadcasting terminal, a personal digital assistant (PDA), a portable multimedia player (PMP), a tablet PC, and the like. As one example, the user terminal 110 may communicate with other user terminals and/or servers 100, 101 and 102 through the network 120 in a wire or wireless communication scheme.

The communication scheme may include, but is not limited to, wireless local area communication between devices as well as a communication scheme of utilizing a communication network (such as a mobile communication network, wire Internet, wireless Internet or a broadcasting network) which may be included in the network 120. For example, the network 120 may include at least one of a personal area network (PAN), a local area network (LAN), a campus area network (CAN), a metropolitan area network (MAN), a wide area network (WAN), a broadband network (BBN), the Internet, and the like. Further, the network 120 may include, but is not limited to, at least one of the following network topologies, including a bus network, a star network, a ring network, a mesh network, a star-bus network, a tree or hierarchical network, and the like.

Each of the servers 100, 101 and 102 may be implemented by a computer device or a plurality of computer devices which communicates through the network 120 to provide a command, a code, a file, contents, a service, etc.

For example, the server 100 may provide a file for installing an application to the user terminal 110 accessing the server 100 through the network 120. In this case, the user terminal 110 may install the application by using the file provided from the server 100. In addition, the user terminal 110 may have access to the server 100 to obtain a service or contents provided from the server 100 under the control of an operating system (OS) and at least one program (such as a browser or an installed application) included therein. For example, when the user terminal 110 transmits a service request message through the network 120 to the server 100 under the control of an application, the server 100 may transmit a code corresponding to the service request message to the user terminal 110 and then, the user terminal 110 may form and display an image based on the code under the control of the application such that the contents are provided to a user. As another example, the server 100 may establish a communication session for a messaging service and may route messages between the plurality of terminals 110 through the established communication session.

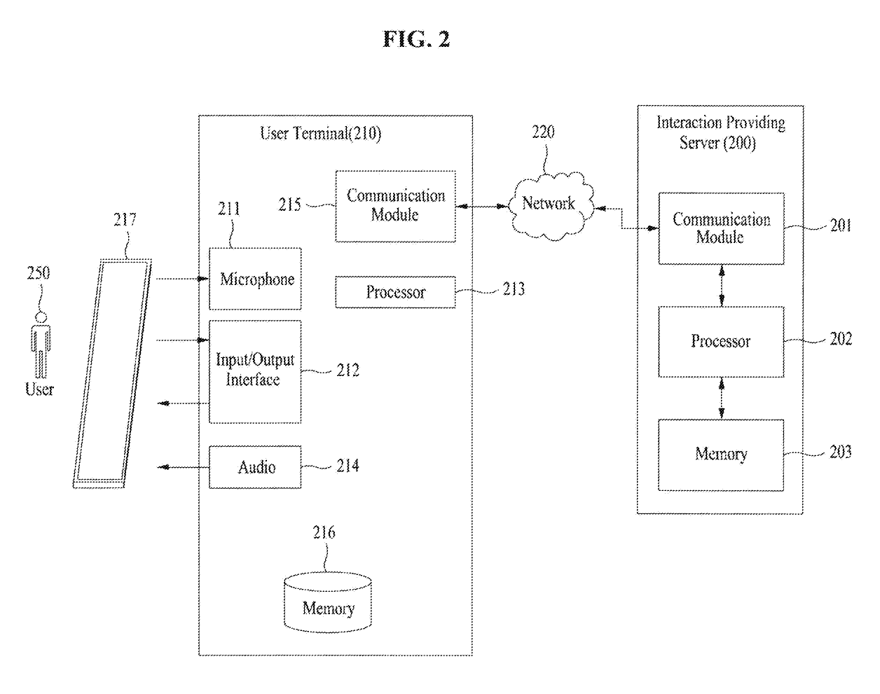

FIG. 2 is a block diagram illustrating the internal configurations of a user terminal and a server according to an embodiment.

FIG. 2 illustrates the internal configurations of a user terminal 210 and an interaction providing server 200 depicted as examples of one of the user terminals 110 and one of the servers 100, 101 or 102, respectively, included in the network environment illustrated in FIG. 1.

The user terminal 210 includes a microphone 211, an input/output interface 212, a processor 213, an audio module 214, a communication module 215, a memory 216, and a display 217. The user terminal 210 may include the processor 213 and at least one application operated therein.

The interaction providing server 200 includes a memory 203, a processor 202, and a communication module 201. The memory 203 or 216, which is a computer-readable recording medium, may include a random access memory (RAM), a read only memory (ROM), and a permanent mass storage device such as a disk drive. In addition, an operating system and at least one program code (which is, for example, a code for a browser or the above-described application installed and operated in the user terminal 210) may be stored in the memory 203 or 216. Such software elements may be loaded from a computer-readable recording medium separated from the memory 203 or 216 by using a drive mechanism. The separate computer-readable recording medium may include a computer-readable recording medium such as a floppy drive, a disk, a tape, a DVD/CD-ROM drive, a memory card, and the like. According to another embodiment, software elements may be loaded into the memory 203 or 216 through the communication module 201 or 215 rather than the computer-readable recording medium. For example, at least one program may be loaded into the memory 203 or 216 based on a program (for example, the above-described application) installed with files which developers or a file distribution system (for example, the above-described interaction providing server 200) for distributing an installation file of an application provides through the network 220.

The processor 202 or 213 may be configured to process commands of a computer program by performing basic arithmetic, logic, and input/output arithmetic operations. The command may be provided to the processor 202 or 213 through the memory 203 or 216 or the communication module 201 or 215. For example, the processor 202 or 213 may be configured to execute the received command based on the program code stored in the recording device such as the memory 203 or 216.

The communication modules 201 and 215 may provide a function of allowing the user terminal 210 and the interaction providing server 200 to communicate with each other through the network 220, and may provide a function of allowing another client and another server to communicate with each other. For example, the processor 213 of the user terminal 210 may transmit a request that is generated based on the program code stored in a recording device such as the memory 216 through the network 220 to the interaction providing server 200 under the control of the communication module 215. In contrast, the user terminal 210 may receive a control signal or command, contents, or a file, which is provided under the control of the processor 202 of the interaction providing server 200, through the communication module 215 of the user terminal 210 via the communication module 201 and the network 220. For example, the control signal or command of the interaction providing server 200, which is received through the communication module 215, may be transferred to the processor 213 or the memory 216 and the contents or the file may be stored in a storage medium which may be further included in the user terminal 210.

The input/output interface 212 may be a unit configured to interface with an input/output device. For example, the input device may include devices such as a keyboard, a mouse and the like, and the output device may include devices such as a display configured to display a communication session of an application. As another example, the input/output interface 212 may be a unit configured to interface with a device such as a touchscreen in which input and output functions are integrated. As a more detailed example, the processor 213 of the user terminal 210 may allow service images or contents, which are constructed based on the data provided from the interaction providing server 200 or another terminal, to be displayed on the display 217 through the input/output interface 212 while processing a command of a computer program loaded to the memory 216.

In addition, according to another embodiment, the user terminal 210 and the interaction providing server 200 may further include other elements as well as those of FIG. 2. However, most of conventional elements are not required to be distinctly depicted. For example, the user terminal 210 may be configured to include at least a part of an input/output device or may further include other elements such as a transceiver, a global positioning system (GPS) module, a camera, various kinds of sensors, a database and the like.

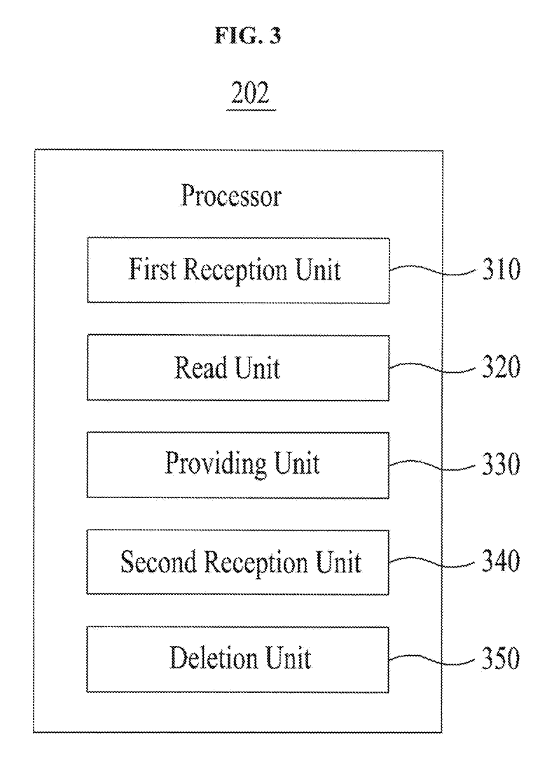

FIG. 3 is a block diagram illustrating examples of elements which may be included in the processor 202 of the interaction providing server 200 according to an embodiment. The processor 202 included in the interaction providing server 200 may include, as elements, a first reception unit 310, a read unit 320, a providing unit 330, a second reception unit 340, and a deletion unit 350. The processor 202 and the elements of the processor 202 may be implemented to execute commands based on operating system codes and codes of at least one program stored in a memory. The elements of the processor 202 may represent mutually different functions performed by the processor 202 according to control commands provided by program codes stored in a game server.

The processor 202 loads a program code stored in a program file for an interaction providing method into the memory 203. Each of the processor 202, and the first reception unit 310, the read unit 320, the providing unit 330, the second reception unit 340 and a deletion unit 350 included in the processor 202 execute a corresponding command among the program codes loaded into the memory 203.

The first reception unit 310 receives a query input from the user terminal 210. Text or audio data may be input to the first reception unit 310 in a word or sentence type.

The read unit 320 reads a query in response to the reception of the query.

When the query is read, the providing unit 330 provides the query and a query result concerning the query to the user terminal 210 such that the query and the query result are output. The providing unit 330 may provide audio and text data corresponding to the query and the query result to the user terminal 210 such that the query and the query result are output. When the query and the query result are output, the providing unit 330 may provide the query result in a short-answer type, i.e., a word or a phrase, or in a conversational sentence type, i.e., a complete sentence. The providing unit 330 may output the query and the query result through an interactive interface of the user terminal 210, and may provide history of the query and the query result to the interactive interface.

The second reception unit 340 receives an input of a swipe command over the query on the display 217 of the user terminal 210. When the query input to the user terminal 210 is erroneously read so that the erroneously read query and query result are output or the query is re-input, the second reception unit 340 may input the swipe command over the query. When the swipe command for the query which is desired to be deleted among the queries and the query result output to the user terminal 210 is input, the second reception unit 340 may selectively delete the query over which the swipe command is input and the query result.

When the input of the swipe command over the query is received, the deletion unit 350 deletes the query and the query result. The deletion unit 350 may output a pop-up window, which is configured to determine whether to cancel the deletion of the query and the query result, to the user terminal 210 for a predetermined time. When an input of a deletion cancel command to cancel the deletion of the query is received through the pop-up window output to the user terminal 210, the deletion unit 350 may restore the query and the query result.

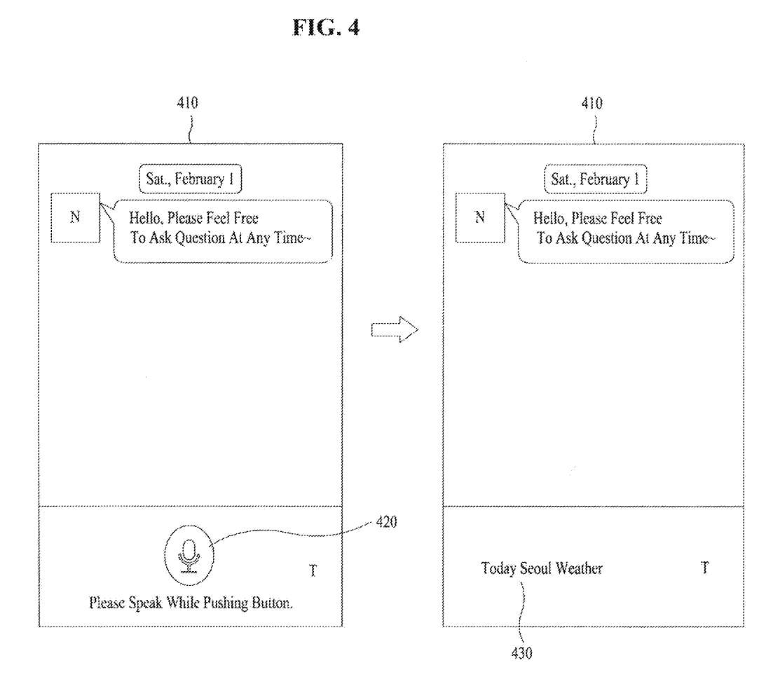

FIG. 4 is a view illustrating an example of a query input from the user terminal 210 according to an embodiment.

An operation between the interaction providing server 200 and the user terminal 210 for an interactive search service will be described with reference to FIGS. 4 to 7, where the operation of FIGS. 4 to 7 may be applied to a message service performed between user terminals 110 as well as the interactive search service in the same manner. For example, in an interactive interface through which a user transmits/receives messages to/from another user through the user terminal 210, when the messages transmitted and received between users are to be deleted, the messages may be deleted by inputting the swipe command over the messages. The date and time, at which a query is input and the query result of the query is output to the interactive search interface for providing an interactive search service and the interactive interface for transmitting/receiving a message, may be provided.

Referring to FIG. 4, the interaction providing server 200 may provide the interactive search service to the user terminal 210. For example, when a user allows his user terminal 210 to execute the interactive search service, the interactive search service may be provided. As the interactive search service is executed, the interaction providing server 200 may provide an interactive search interface 410 on the display 217 of the user terminal 210 for providing the interactive search service to the user terminal 210.

When a user inputs a query for search in a voice or text type through his user terminal 210, the interactive search interface 410 may output a query result concerning the query, which is provided from the interaction providing server 200.

As the interactive search service is executed, the user may input a query on the interactive search interface 410. The interaction providing server 200 may provide a query input interface 420 through which a user inputs a query into the interactive search interface. The user may select the query input interface 420 in the interactive search interface 410. When the user inputs a query after selecting the query input interface 420, the interaction providing server 200 may receive the query input from the user.

For example, it is assumed that a query of ‘Today Seoul Weather’ is input. In this case, the user may input the query in a voice or text type. In addition, the user may variously input the query in a word or sentence type. The interaction providing server 200 may receive audio or text data input from the user in a word or text type.

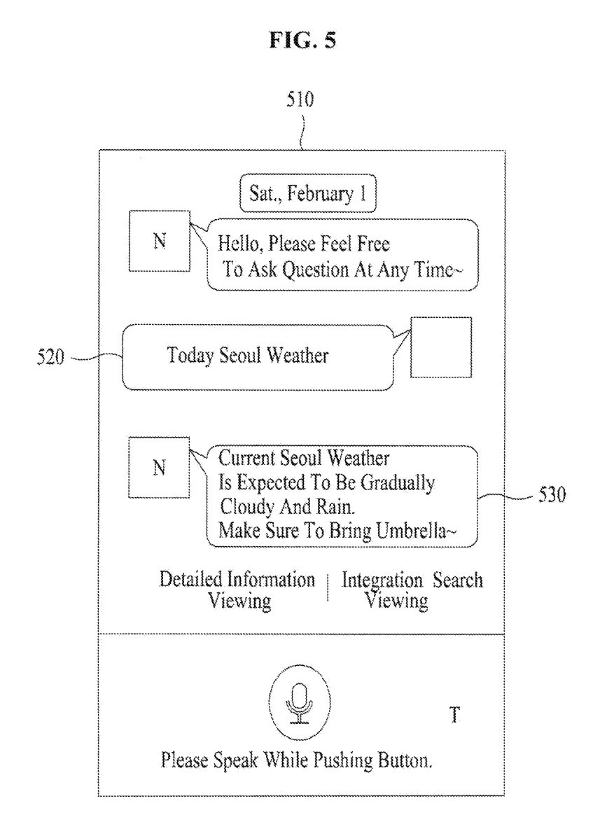

FIG. 5 is a view illustrating an example of a query result to an input query according to an embodiment.

When a query is input through the user terminal 210, the interaction providing server 200 may provide a query result concerning the query to an interactive search interface 510 such that the query result is output. The user terminal 210 may output the query 520 and the query result 530 provided from the interaction providing server 200 to the interactive search interface 510 on the display 217 of the user terminal 210.

For example, if a user has input a query 520 of ‘Today Seoul Weather’, the query 520 of ‘Today Seoul Weather’ may be output to the interactive search interface 510. The interaction providing server 200 may read the query in response to the reception of the query input from the user. For example, the interaction providing server 200 may extract a core keyword from the query and read the extracted core keyword to perform the search for the core keyword, such that the query result may be obtained. The interaction providing server 200 may obtain the query result from information stored in the database or through web search.

As the query is read, the interaction providing server 200 may provide the query 520 and the query result 530 concerning the query to the user terminal 210 such that the query 520 and the query result 530 are output. In this case, the query and the query result may be output to the interactive search interface 510.

The interaction providing server 200 may provide a message of ‘Current Seoul weather is expected to be gradually cloudy and rain. Make sure to bring umbrella.’, as the query result to the query 520 input by the user. In this case, the interaction providing server 200 may provide audio and text data corresponding to the query result. In addition, the interaction providing server 200 may provide the query result 530 in a short-answer type or a conversational sentence type.

Thus, when the user inputs the query in voice through the user terminal 210, the query 520 and the query result 530 may be provided to the user terminal 210 in text and at the same time, the query result 530 may be output in voice.

The interaction providing server 200 may provide the query 520 input from a user and the query result 530 in a search or card type. For example, in the search type, when the user inputs the query 520 on the interactive search interface 510, the interaction providing server 200 may provide the query result 530 to the query on the same interactive search interface 510. In addition, in the card type, when the user inputs the query 520 on the interactive search interface 510, the interaction providing server 200 may provide the query result 530 to the query through a separate query result interface on the display 217 of the user terminal 210.

The interaction providing server 200 may provide information about details of the query result 530 and integration search through the interactive search interface 510. For example, the interaction providing server 200 may provide a detail information interface for providing information about details of the query result 530 and an interface for providing the integration search to the interactive search interface 510. When a user selects the detail information interface, the interaction providing server 200 may provide information about details of the query result 530 on the display 217. In addition, when a user selects the integration search interface, the interaction providing server 200 may interwork with an Internet search engine (not shown) to perform the integration search for the query 520 and the query result 530, such that integration search information is provided on the display 217. Integration search information can be obtained through search service for the query 520 and the query result 530.

In addition, the interaction providing server 200 may output the query 520 and the query result 530 to the interactive search interface 510 of the user terminal 210, and may provide the history of the query and the query result to the interactive search interface 510. In other words, a user may view the history of the query 520 and the query result 530 which have been displayed on the interactive search interface 510.

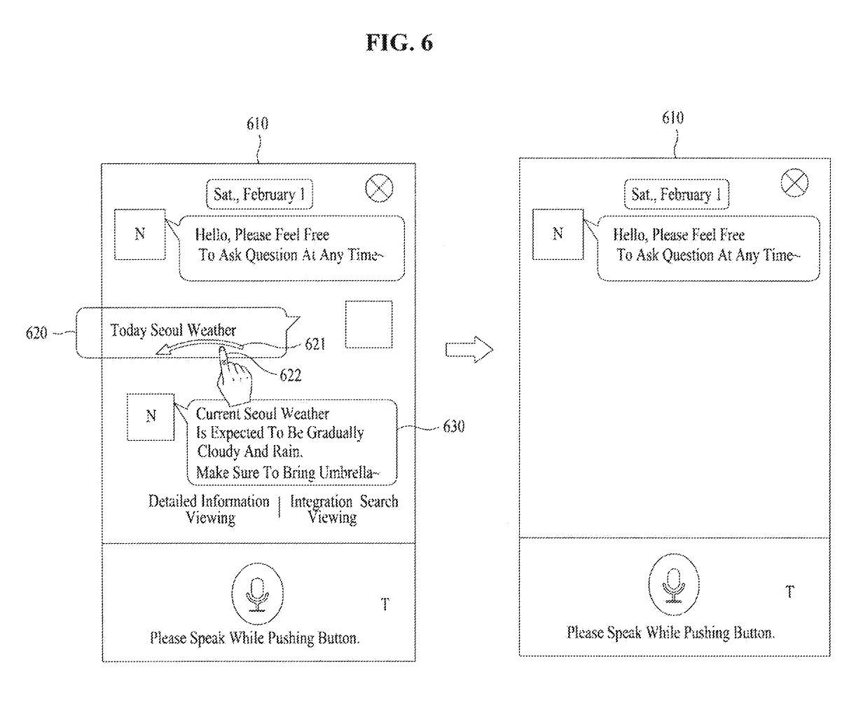

FIG. 6 is a view illustrating an example of a deletion of a query according to an embodiment.

The interaction providing server 200 may receive from the user terminal 210 the fact that a swipe command 621 is input over a query 620 through the interactive search interface 610 output to the user terminal 210. When the user determines that an error exists in the query 620 and a query result 630 output to the interactive search interface 610, the swipe command may be input over the query 620 desired to be deleted. For example, the interaction providing server 200 may have erroneously read the query input from the user terminal 210, or although the query had been correctly input, may have erroneously output the query result.

The interaction providing server 200 may provide the erroneously read query and the query result to the interactive search interface 610 such that the incorrectly read query and the query result are output. In this case, since the erroneously read query and the query result are output to the user terminal 210, the user may decide to delete the erroneously read query.

The interaction providing server 200 may receive from the user terminal 210 the fact that the swipe command 621 is input over the query 620. In this case, the swipe may imply that the query is deleted by moving a finger 622 from right to left while the finger is not separated from the screen of the user terminal 210. The interaction providing server 200 may set a swipe command 621 for deleting a query. For example, the interaction providing server 200 may be set to delete a query when sensing a finger movement from right to left.

In other words, the user may move the query 620 to right to left while making contact with the screen of the user terminal 210. Thus, the interaction providing server 200 may delete the query 620 and the query result 630. In addition, when the user inputs the swipe command 621 over the query, the interaction providing server 200 may provide an interface of inquiring whether the query 620 is to be really deleted before deleting the query 620. When the interaction providing server 200 receives, from the user, a confirmation of the deletion of the query 620 over which the swipe command 621 is input, the interaction providing server 200 may delete the query 620 and the query result 630.

When the interaction providing server 200 receives from the user terminal 210 the fact that the swipe command 621 is input over the query 620, which is output to the user terminal 210, the interaction providing server 200 deletes the query 620 and the query result 630. The interaction providing server 200 then outputs the interactive search interface 610, in which the query 620 and the query result 630 are deleted, to the user terminal 210.

In addition, the interaction providing server 200 may provide the query 620 input by the user in the past and the corresponding query result 630 to the interactive search interface 610, and the user 622 may selectively delete the query 620 and the query result 630. Thus, when the swipe command 621 is input over the selected query 620, the user terminal 210 may delete the query 620 input in the past and the corresponding query result 630.

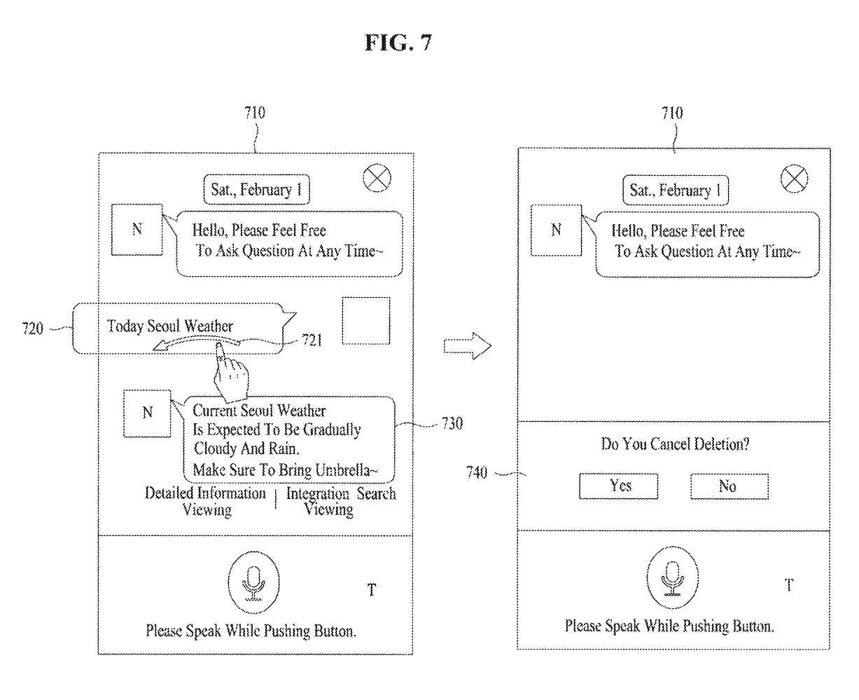

FIG. 7 is a view illustrating an example of restoring a query according to an embodiment.

When the interaction providing server 200 receives the fact that a swipe command 721 is input over a query 720, which is output to the user terminal 210, the interaction providing server 200 deletes the query 720 and a corresponding query result 730. The interaction providing server 200 then outputs an interactive search interface 710, in which the query 720 and the query result 730 are deleted, to the user terminal 210.

The interaction providing server 200 may also provide a pop-up window 740 for inquiring of the user whether to delete the query 720 over which the swipe command 721 has been input, such that the pop-up window 740 is output to the user terminal 210. The pop-up window 740 for determining whether the deletion of the query and the query result should be cancelled may be output to the user terminal 210 for a preset time. When a deletion cancel command for cancelling the deletion of the query is input through the pop-up window 740 output to the user terminal 210, the query 720 and the query result 730 may be restored.

For example, when the user inputs the swipe command 721 over the query 720 through the interactive search interface 710 of the user terminal 210, the interaction providing server 200 may delete the query 720 and the query result 730. In the event the user may have deleted the query 720 by mistake, the interaction providing server 200 may provide the pop-up window 740 for inquiring whether to cancel the deletion, such that the query 720 is restored. When the user selects a deletion cancel interface from the pop-up window 740 output to the interactive search interface 710, the interaction providing server 200 may restore the query 720 and the query result 730.

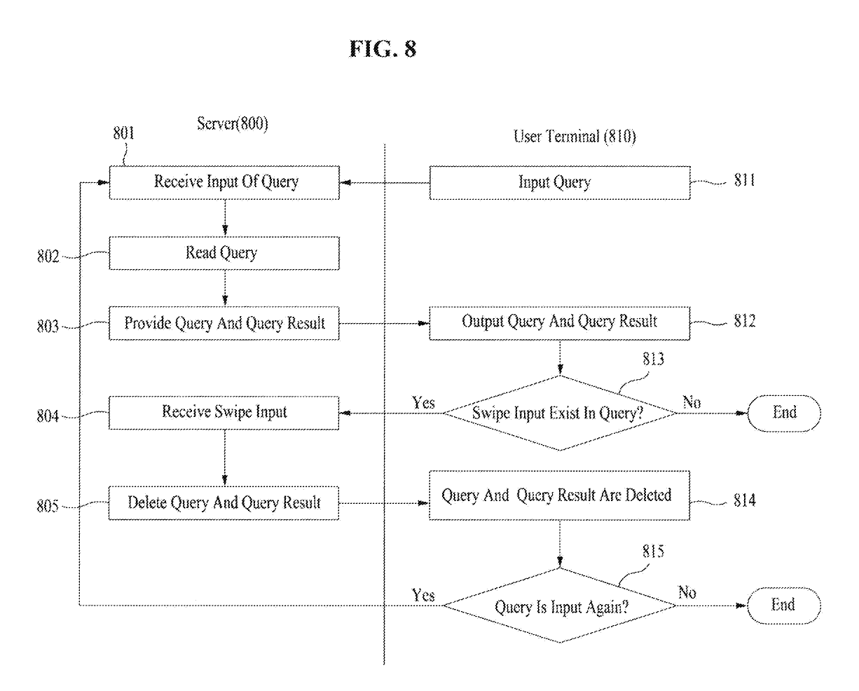

FIG. 8 is a flowchart illustrating a method of providing interaction between the user terminal 210 and the interaction providing server 200 according to an embodiment.

In step 811, a query is input to the user terminal 210. For example, a user may input the query to the user terminal 210 in a voice or text, or in a word or sentence type. In step 801, the interaction providing server 200 receives the input of the query from the user terminal 210.

In step 802, the interaction providing server 200 reads the query in response to the reception of the query input. In step 803, when the query is read, the interaction providing server 200 provides the query and the query result concerning the query to the user terminal 210 such that the query and the query result are output. In step 812, the user terminal 210 outputs the query and the query result on the interactive search interface on the display 217 of the user terminal 210. (See, e.g., FIG. 6.) In this case, the query and the query result may be output to the user terminal 210 together with audio and text data, and the query result may be provided in a short-answer type or in a conversational sentence type.

In step 813, the user terminal 210 determines whether the swipe command is input over the query displayed on the search interface. For example, when the query input from the user terminal 210 is erroneously read so that the erroneously read query and the query result are output, or the query is re-input after the output query is deleted, the swipe command may be input over the query. In step 804, when the swipe command is input over the query on the user terminal 210, and the interaction providing server 200 receives the swipe command input from the user terminal 210. When a swipe command input over the query from the user does not exist, the process is terminated.

In step 805, when the interaction providing server 200 receives the input of the swipe command from the user terminal 210, the interaction providing server 200 deletes the query over which the swipe command is input and the query result. In step 814, the query and the query result are deleted from the user terminal 210. In step 815, the user may re-input a query through the user terminal 210. When the query is re-input from the user terminal 210, the process of steps 801 to 805 and 812 to 815 is repeated. In addition, when no inquiry is re-input to the user terminal 210, the process is terminated.

According to the embodiments, when the query and the query result are corrected, the interaction providing server 200 deletes the query and the query result by allowing the swipe command to be input over the query displayed on the interactive search interface such that the query is input again, so that the procedure of correcting a query may be simplified and convenience in use may be provided to a user.

According to the embodiments, when the swipe command is input over the query, the interaction providing server 200 may delete the query and the query result and may induce the query to be input again, such that the query is more rapidly corrected, thereby optimizing mobile environment.

The foregoing devices or units may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable gate array (FPGA), a programmable logic unit (PLU), a microprocessor or any device which may execute instructions and respond. A processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, it is intended that the inventive concept covers other realizations and other embodiments of this invention provided they come within the scope of the appended claims and their equivalents.

What is claimed is:

1. An interaction providing method implemented by a computer, for deleting a query input in a user terminal, the interaction providing method comprising:
receiving the query from the user terminal;
reading the query in response to the receiving of the query;
providing the query and a query result concerning the query to the user terminal in response to the reading of the query such that the query and the query result are output;
receiving an input of a swipe command over the query output to the user terminal; and
deleting the query and the query result in response to the receiving of the input of the swipe command over the query.

2. The interaction providing method of claim 1, wherein the query is received from the user terminal in text or audio data.

3. The interaction providing method of claim 1, wherein the providing of the query and the query result to the user terminal comprises providing audio and text data corresponding to the query and the query result to the user terminal such that the audio and text data are output.

4. The interaction providing method of claim 3, wherein the providing of the query and the query result to the user terminal comprises providing the query result in a short-answer type or in a conversational sentence type when the query and the query result are output.

5. The interaction providing method of claim 1, wherein the providing of the query and the query result comprises outputting the query and the query result through an interactive interface of the user terminal and providing history of the query and the query result to the interactive interface.

6. The interaction providing method of claim 1, wherein the receiving of the swipe command comprises, when the query input over the user terminal is erroneously read, inputting the swipe command over the query if the erroneously read query and query result are output.

7. The interaction providing method of claim 1, wherein the receiving of the swipe command comprises, when a swipe command over a query, which is desired to be deleted among the query and the query result output to the user terminal, is input, selectively deleting the query over which the swipe command is input and the query result.

8. The interaction providing method of claim 1, wherein the deleting of the query and the query result comprises outputting a pop-up window configured to determine whether to cancel the deletion of the query and the query result, to the user terminal for a time.

9. The interaction providing method of claim 8, wherein the deleting of the query and the query result comprises, when a deletion cancel command to cancel the deletion of the query is received, restoring the query and the query result, and
wherein the deletion cancel command is input through the pop-up window output to the user terminal.

10. A non-transitory computer-readable recording medium storing a computer program, which when executed by a computer, causing the computer to perform an interaction providing method for deleting a query input into a user terminal, the interaction providing method comprising:
receiving the query from the user terminal;
reading the query in response to the receiving of the query;
providing the query and a query result concerning the query to the user terminal in response to the reading of the query such that the query and the query result are output;
receiving an input of a swipe command over the query output to the user terminal; and
deleting the query and the query result in response to the receiving of the input of the swipe command over the query.

11. A server for providing an interaction for deleting a query input into a user terminal, the server comprising:
a first reception unit configured to receive a query from the user terminal;
a read unit configured to read the query in response to the receiving of the query;
a providing unit configured to provide the query and a query result concerning the query to the user terminal in response to the reading of the query such that the query and the query result are output;
a second reception unit configured to receive an input of a swipe command over the query output to the user terminal; and
a deletion unit configured to delete the query and the query result in response to the receiving of the input of the swipe command over the query.

12. The server of claim 11, wherein the query is received by the first reception unit in text or audio data.

13. The server of claim 11, wherein the providing unit provides audio and text data corresponding to the query and the query result to the user terminal such that the audio and text data are output.

14. The server of claim 13, wherein the providing unit provides the query result in a short-answer type or in a conversational sentence type when the query and the query result are output.

15. The server of claim 11, wherein the providing unit outputs the query and the query result through an interactive interface of the user terminal and provides history of the query and the query result to the interactive interface.

16. The server of claim 11, wherein, when the query from the user terminal is erroneously read, the second reception unit inputs the swipe command over the query if the erroneously read query and query result are output.

17. The server of claim 11, wherein, when a swipe command that a query is desired to be deleted among the query output to the user terminal and the query result is input, the second reception unit selectively deletes the query over which the swipe command is input and the query result.

18. The server of claim 11, wherein the deletion unit outputs a pop-up window configured to determine whether to cancel the deletion of the query and the query result to the user terminal for a time.

19. The server of claim 18, wherein, when a deletion cancel command to cancel the deletion of the query is received, the deletion unit restores the query and the query result, and wherein the deletion cancel command is input through the pop-up window output to the user terminal.
